(19) United States
(12) Patent Application Publication
(10) Pub. No.: US 2012/0086948 A1
(43) Pub. Date: Apr. 12, 2012

(54) OPTICAL COHERENCE TOMOGRAPHY APPARATUS FOR ENHANCED AXIAL CONTRAST AND REFERENCE MIRROR HAVING MULTIPLE PLANES FOR THE SAME

(75) Inventor: Hyun Woo SONG, Daejeon (KR)

(73) Assignee: Electronics and Telecommunications Research Institute, Daejeon (KR)

(21) Appl. No.: 13/268,112

(22) Filed: Oct. 7, 2011

(30) Foreign Application Priority Data
Oct. 8, 2010 (KR) 10-2010-0098444
Mar. 16, 2011 (KR) 10-2011-0023278

(51) Int. Cl. G01B 9/02

(52) U.S. Cl. 356/479

(57) ABSTRACT

In the OCT apparatus, the reference mirror is a mirror having a multi-layer structure having at least two planes and includes a first plane and at least one second plane having a height difference corresponding to ¼ length of a central wavelength of the light source or an odd multiple of ¼ length with respect to the first plane such that beams reflected by the planes have a phase shift corresponding to a half wavelength or an odd multiple of the half wavelength. Since a bandwidth of a light source is not increased, large broadband performance of optical parts is not required and neither is dispersion compensation of the path in each coherence arm. Therefore, the OCT apparatus using the reference mirror can be applied in industries that require various precise thick film techniques through the tomography image having the remarkably enhanced contrast in the depth direction.

### CLAIM FOR PRIORITY

This application claims priority to Korean Patent Application No. 10-2010-0098444 filed on Oct. 8, 2010 and Korean Patent Application No. 10-2011-0023278 filed on Mar. 16, 2011 in the Korean Intellectual Property Office (KIPO), the entire contents of which are hereby incorporated by reference.

### BACKGROUND

1. Technical Field

Example embodiments of the present invention relate in general to an optical coherence tomography (OCT) technique, and more specifically, to an OCT apparatus for enhanced axial contrast in an OCT technique including a Michelson interferometer to obtain a coherence tomography image, for the purpose of obtaining an image in a depth direction of an optically transparent object including a living body, and a reference mirror used therein.

2. Related Art

An OCT technique is a technique of moving a reference mirror, one element of a Michelson interferometer, to obtain an optical coherence signal having information in a depth direction of an object to be measured, and scanning a sample mirror to obtain an optical coherence signal perpendicular thereto, thereby acquiring a two-dimensional (or three-dimensional) coherence tomography image of the object to be measured.

Such an OCT technique has been proposed by Fujimoto Group of MIT University of USA, 1991, and has attracted the attention of many people (D. Huang, E. A. Swanson, C. P. Lin, J. S. Schuman, W. G. Stinson, W. Chang, M. R. Hee, T. Flotte, K. Gregory, C. A. Puliafito, J. G. Fujimoto, “Optical Coherence Tomography,” Science, vol. 254, 1178˜1181, Nov. 22, 1991.), and is now being commercialized and used worldwide mainly for ophthalmic medical instruments.

In addition, in order to obtain a signal in a depth direction of an OCT apparatus, techniques of very rapidly moving a reference mirror to remarkably increase an image acquisition speed have been disclosed (G. Tearney, E. Bouma, J. G. Fujimoto, “Grating based phase control optical delay line,” U.S. Pat. No. 6,282,011 B1, Aug. 28, 2001.). These techniques enable a very fast optical phase and group delay by attaching a reference mirror to a polygonal rotary body and positioning an optical grating between an optical branching filter and the reference mirror.

Further, a technique of introducing a classical method used in a microscope to an OCT technique to increase contrast in a surface direction (parallel to a surface) has been disclosed (A. F. Fercher, “Methods and arrangement for increasing contrast in optical coherence tomography by means of scanning an object with a dual beam,” U.S. Pat. No. 5,877,856, Mar. 2, 1999.). Such a technique, which is capable of improving contrast in a surface image, involves dividing an amplitude in a minute angle before arrival at a sample scanning mirror to irradiate two beams to an object to be measured. The two closely adjacent beams irradiated to the object to be measured have a path difference (phase shift) corresponding to a half wavelength and are destructively interfered with each other to improve the contrast in the surface image.

Meanwhile, such an OCT technique is used in industries that require various thick film techniques, such as a pharmaceutical industry, a semiconductor industry, a plastic element industry, a transparent element industry, and a medical instrument industry. In order to accomplish the industrial object, it is essential to obtain high resolution in a depth direction.

In order to obtain the high resolution in the depth direction, various research groups have continued their efforts of developing light sources of very wide bandwidths. When the broadband light sources are used, a coherence length is reduced to obtain a coherence signal having a very narrow space width from a reflective surface of the object to be measured, and thus, the resolution in the depth direction can be increased. For this, a broadband light source having a very large line width of hundreds of nm has been developed.

However, in addition to use of the above-mentioned broadband light source, the other various optical parts of the interferometer system must support the very large line width to obtain the anticipated resolution in the depth direction.

That is, when the bandwidth of the light source is increased, high broadband performance of the other optical parts of the OCT apparatus is required, and dispersion compensation of a path in each coherence arm is also required.

### SUMMARY

Accordingly, example embodiments of the present invention are provided to substantially obviate one or more problems due to limitations and disadvantages of the related art.

Example embodiments of the present invention provide an OCT apparatus including a Michelson interferometer capable of obtaining high resolution in a depth direction of an optically transparent object to be measured including a living body.

Example embodiments of the present invention also provide a reference mirror having multiple planes that can be applied to an OCT apparatus including a Michelson interferometer and capable of obtaining high resolution in a depth direction of an optically transparent object to be measured including a living body.

In some example embodiments, an OCT apparatus is configured to branch and irradiate beams emitted from a light source to a reference mirror and a sample mirror, and obtain a coherence tomography image of an object to be measured through a coherence signal generated by a path difference between the beam reflected by the reference mirror and the beam reflected by the object to be measured via the sample mirror, wherein the reference mirror is a multiple-plane reference mirror having at least two planes, and configured such that the beams reflected from the planes have a phase shift corresponding to a half wavelength or an odd multiple of the half wavelength.

Here, the reference mirror may include a first plane; and at least one second plane having a height difference corresponding to ¼ length of a central wavelength of the light source or an odd multiple of ¼ length with respect to the first plane.

Here, the reference mirror may have three planes, and an area ratio of the first plane and the second and third planes may be determined in proportion to a ratio of light intensity of a central signal of the coherence signal and light intensity of a first fine modulation signal.

Here, the reference mirror may be constituted by unit patterns having at least two planes and distributed on a surface of the reference mirror. At this time, the unit patterns may have a size larger than a central wavelength of the light source.

In other example embodiments, an OCT apparatus, which includes a light source and an optical detection part, includes an optical branching filter configured to amplitude-divide beams emitted from the light source; a reference mirror having multiple planes configured to reflect the beams divided from the optical branching filter and introduce the reflected beams of the divided beams into the optical detection part; a sample mirror configured to irradiate the beams divided from the optical branching filter to a surface of an object to be measured, and introduce the beams reflected from the object to be measured into the optical detection part; and a control unit configured to move the reference mirror onto a path axis of the divided beam to adjust a reflected beam path of the divided beam, and rotate the sample mirror to move the beam irradiated onto the surface of the object to be measured, wherein the reference mirror is a multiple-plane reference mirror having at least two planes, and is configured such that the beams reflected from the planes have a phase shift corresponding to a half wavelength or an odd multiple of the half wavelength. The optical branching filter may be an optical beam splitter or an optical fiber coupler to be used to divide and combine light amplitude in Michelson configuration.

Here, the reference mirror may include a first plane; and at least one second plane having a height difference corresponding to ¼ length of a central wavelength of the light source or an odd multiple of ¼ length with respect to the first plane.

Here, the reference mirror may have three planes, and an area ratio of the first plane and the second and third planes may be determined in proportion to a ratio of light intensity of a central signal of the coherence signal and light intensity of a first fine modulation signal.

Here, the reference mirror may be constituted by unit patterns having at least two planes and distributed on a surface of the reference mirror. At this time, the unit patterns may have a size larger than a central wavelength of the light source.

Here, the optical detection part may include a focusing lens configured to focus the beams from the reference mirror and the sample mirror; an iris configured to adjust a quantity of the beams passed through the focusing lens; and an optical detector configured to detect the beam passed through the iris.

In still other example embodiments, a reference mirror applied to an OCT apparatus configured to branch and irradiate beams emitted from a light source to a reference mirror and a sample mirror, and obtain a coherence tomography image of an object to be measured through a coherence signal generated by a path difference between the beam reflected by the reference mirror and the beam reflected by the object to be measured via the sample mirror, includes a first plane; and at least one second plane having a height difference corresponding to ¼ length of a central wavelength of the light source or an odd multiple of ¼ length with respect to the first plane.

Here, the reference mirror may have three planes, and an area ratio of the first plane and the second and third planes may be determined in proportion to a ratio of light intensity of a central signal of the coherence signal and light intensity of a first fine modulation signal.

Here, the reference mirror may be constituted by unit patterns having at least two planes and distributed on a surface of the reference mirror. According to this time, the unit patterns may have a size larger than a central wavelength of the light source.

### BRIEF DESCRIPTION OF DRAWINGS

Example embodiments of the present invention will become more apparent by describing in detail example embodiments of the present invention with reference to the accompanying drawings, in which:

FIG. 1 is a conceptual view for explaining a configuration of an OCT apparatus according to the related art;

FIG. 2 is a light intensity output signal graph of an object to be measured in a depth direction of the OCT apparatus according to the related art;

FIG. 3 is a conceptual view for explaining a configuration of an OCT apparatus in accordance with an example embodiment of the present invention;

FIG. 4 is a cross-sectional view of a multiple-plane reference mirror applied to the OCT apparatus in accordance with the example embodiment of the present invention;

FIG. 5 is a conceptual view for explaining the multiple planes of the reference mirror used in the OCT apparatus in accordance with an example embodiment of the present invention; and

FIG. 6 is a light intensity output signal graph of an object to be measured in a depth direction of the OCT apparatus in accordance with an example embodiment of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, A, B, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments in accordance with the present invention will be described in detail with reference to the accompanying drawings.

Configuration of OCT Apparatus having Michelson Interferometer

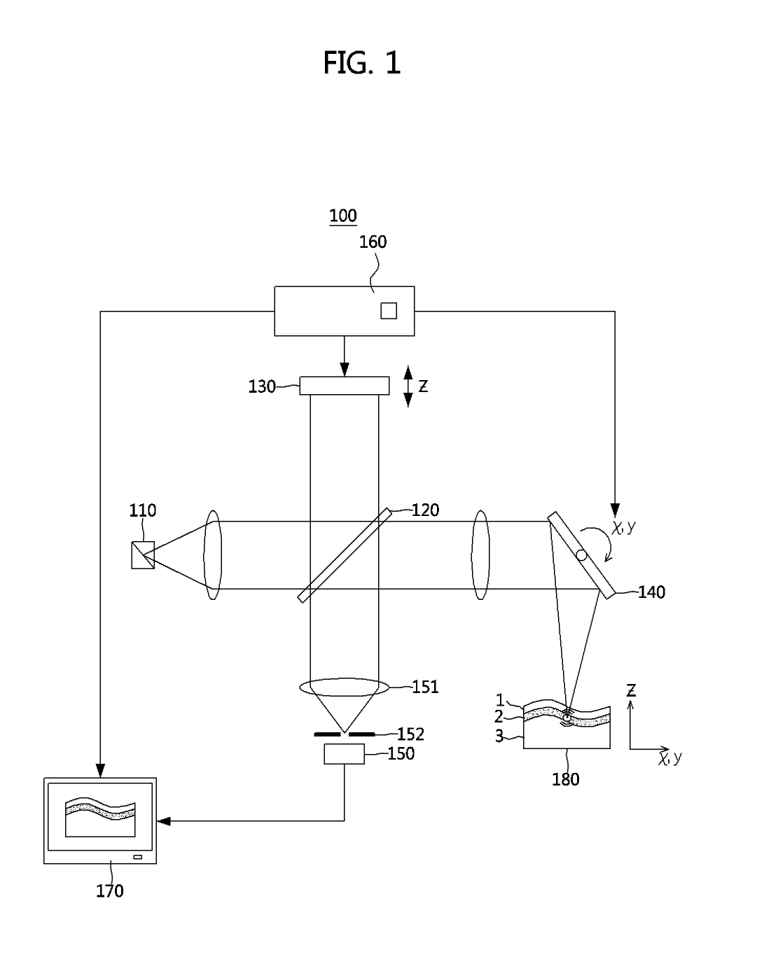

FIG. 1 is a conceptual view for explaining a configuration of an optical coherence tomography (OCT) apparatus according to the related art.

That is, in FIG. 1, the configuration of a time domain OCT apparatus having a Michelson interferometer is shown.

Referring to FIG. 1, an OCT apparatus 100 of the related art may include a broadband light source 110, an optical branching filter 120, a reference mirror 130, a sample mirror (a scanner) 140, a focusing lens 151, an iris 152, an optical detector 150, a control unit 160, and an image display unit 170, and may be configured to obtain an image of an object to be measured 180.

First, beams output from the broadband light source 110 are amplitude-divided using the optical branching filter 120 to be sent to the reference mirror 130 and the scanner, i.e., the sample mirror 140.

These two optical beams are reflected by the reference mirror 130 and a living object (or an object to be measured) 180 to be joined again at the optical branching filter 120 and detected as a signal by the optical detector 150 through the focusing lens 151 and the iris 152. That is, the focusing lens 151, the iris 152 and the optical detector 150 constitute an optical detection part. The optical branching filter may be an optical beam splitter or an optical fiber coupler to be used to divide and combine light amplitude in Michelson configuration.

At this time, the signal detected by the optical detector 150 is a coherence light intensity value of the light reflected by the object to be measured 180 adjacent to a focal point of the focusing lens 151. In order to obtain a coherence tomography image, the control unit 160 drives the scanner including the sample mirror 140 in a surface direction of the object to be measured 180 and drives the reference mirror 130 in a depth direction to obtain the coherence light intensity at each position, realizing a tomography image at the image display unit 170.

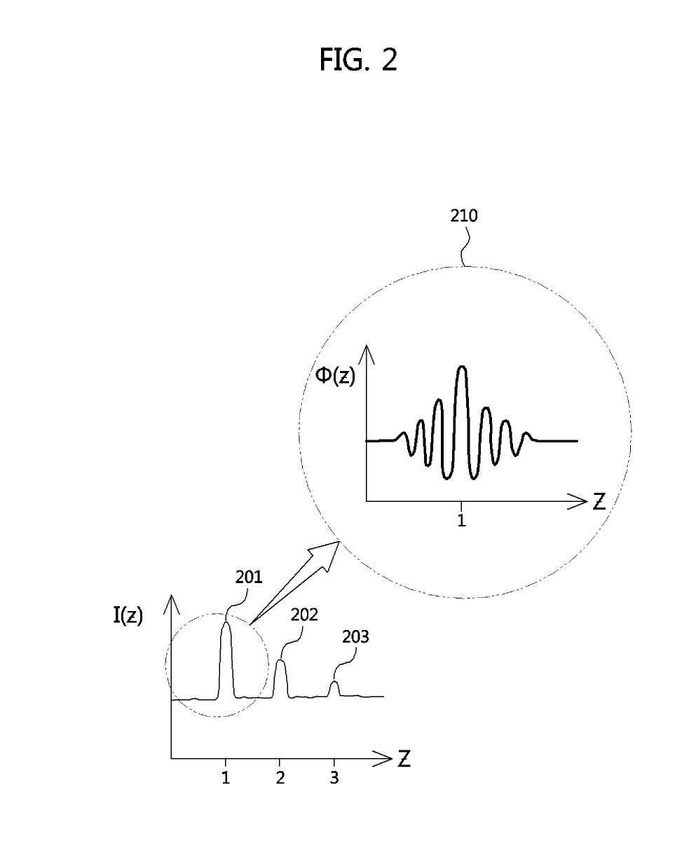

FIG. 2 is a light intensity output signal graph of an object to be measured in a depth direction of the OCT apparatus according to the related art.

Referring to FIGS. 1 and 2, it will be appreciated that strong coherence signals 201, 202 and 203 can be obtained from reflective surfaces 1, 2 and 3 in the living object 180 according to movement of the reference mirror 130, and the OCT apparatus detects the coherence signals to obtain the image in the depth direction.

The coherence signals from the reflective surfaces 1, 2 and 3 have space widths determined by a central wavelength and a bandwidth of the light source 110, and thereby, resolution of the image in the depth direction is determined. In addition, it will be appreciated that, carefully reviewing the coherence signals at the reflective surfaces, fine modulations are included therein (see 210 of FIG. 2).

Configuration of OCT Apparatus According to the Embodiment

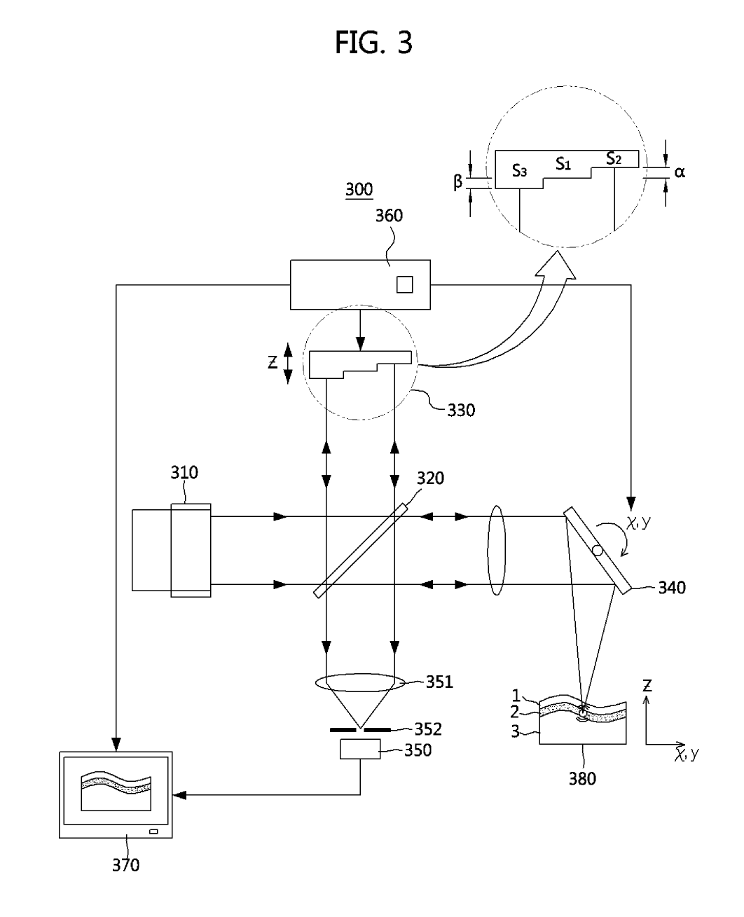

FIG. 3 is a conceptual view for explaining a configuration of an OCT apparatus in accordance with an example embodiment of the present invention.

An OCT apparatus 300 in accordance with the embodiment shown in FIG. 3 also includes a broadband light source 310, an optical branching filter 320, a reference mirror 330, a scanner 340 including a sample mirror, a focusing lens 351, an iris 352, an optical detector 350, a control unit 360, and an image display unit 370, which may be configured to obtain an image of an object to be measured 380. Here, the focusing lens 351, the iris 352 and the optical detector 350 constitute an optical detection part. The focusing lens 351 focuses the beams from the reference mirror and the sample mirror, the iris 352 adjusts the quantity of the beams passed through the focusing lens, and the optical detector 350 detects the beams passed through the iris 352. The optical branching filter may be an optical beam splitter or an optical fiber coupler to be used to divide and combine light amplitude in Michelson configuration.

However, the OCT apparatus 300 according to the embodiment may include a multiple-plane reference mirror as the reference mirror 330, unlike the OCT apparatus of the related art shown in FIG. 1.

That is, in the OCT apparatus according to the embodiment, the multiple-plane reference mirror 330 formed at its surface is used such that the beams reflected by the planes have a phase shaft corresponding to a half wavelength or an odd multiple of the half wavelength to remarkably improve the image contrast of the living object in the depth direction.

The multiple-plane reference mirror 330 has at least two layers when seen from a cross-sectional view thereof (the reference mirror 330 shown in FIG. 3 has three layers S₁, S₂ and S₃). A cross-sectional structure of the multi-plane reference mirror is configured such that a thickness (height) difference of the layers S₁, S₂ and S₃ is ¼ length or an odd multiple of ¼ length with respect to a central wavelength of the light source 310. That is, the thickness difference of the layers causes a path difference of the beams arriving at the planes from the light source or the beams reflected by the planes and entering the optical detection part.

While the embodiment of the present invention has described the case in which the multiple-plane reference mirror 330 is applied to the time domain OCT apparatus, the mirror 330 may be applied to a Fourier domain OCT apparatus.

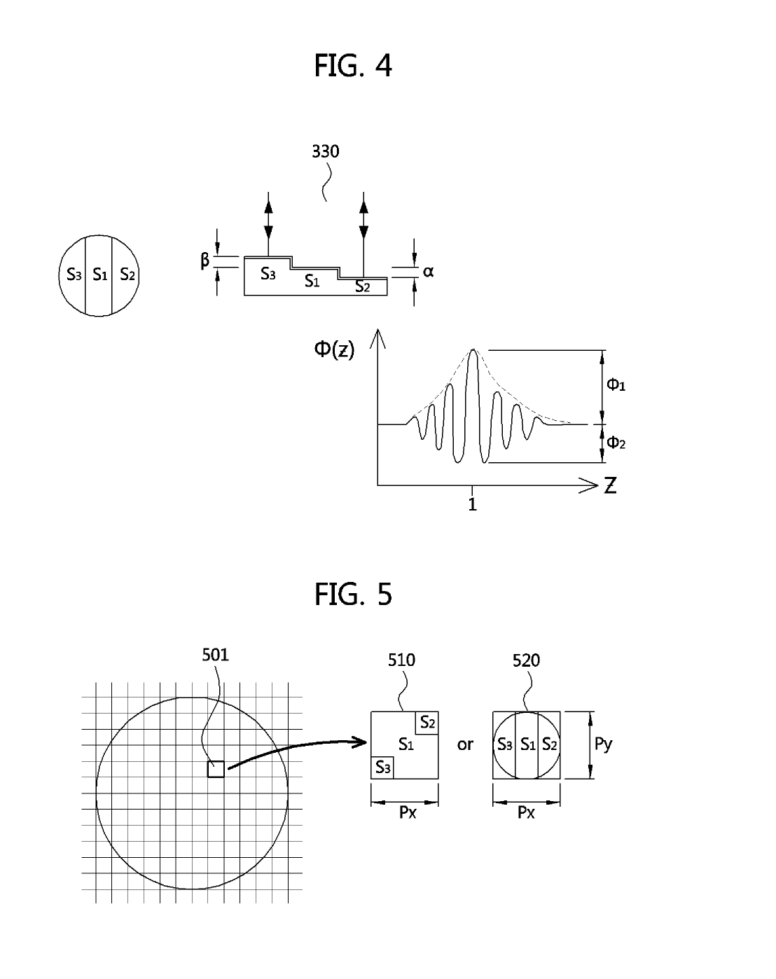

FIG. 4 is a cross-sectional view of the multiple-plane reference mirror applied to the OCT apparatus in accordance with the example embodiment of the present invention.

The multiple-plane reference mirror 330 has at least two layers formed at its cross-section, and the cross-sectional structure of the multiple-plane reference mirror is configured such that a thickness (height) difference (α, β) of the layers is ¼ length or an odd multiple of ¼ length with respect to a central wavelength of the light source 100. That is, the thickness difference causes a path difference of the beams arriving at the planes from the light source or the beams reflected by the planes and entering the optical detection part.

This can be represented by the following formula 1.

$$α ∼ β ∼ n \cdot \frac{{λ}_{0}}{4} \cdot ( n = 1 , 3 , 5 … ) \qquad [ Formula 1 ]$$

FIG. 4 illustrates the case in which the multiple-plane reference mirror 330 has three layers S₁, S₂ and S₃. That is, the number of planes may be three in order to symmetrically offset fine signals around a central signal, rather than the central signal.

In addition, an area ratio of the planes in the plane structure of the multiple-plane reference mirror may be determined in proportion to a ratio of the light intensity of the central signal and the first fine modulation signal light intensity. One of formulae for determining the area ratio of the planes can be represented by the following formula 2.

$$\frac{{S}_{2} + {S}_{3}}{{S}_{1}} ≃ \frac{2 {Φ}_{2}^{2}}{1 {Φ}_{1}^{2}} \qquad [ Formula 2 ]$$

(S₁, S₂ and S₃ are area ratios of the planes, and Φ₁ and Φ₂ are light intensity of the central signal and light intensity of the first fine modulation signal.)

While the area ratio of the planes of the multiple-plane reference mirror is determined as described above, the area ratio of the planes, from which the beam is actually reflected, may be varied according to a diameter of a coherence beam of the OCT apparatus. Accordingly, configuration of the multiple planes may be needed to prevent variation of the area ratio of the planes, from which the beam is actually reflected, according to the diameter of the coherence beam.

FIG. 5 is a conceptual view for explaining the multiple planes of the reference mirror used in the OCT apparatus in accordance with the example embodiment of the present invention.

Referring to FIG. 5, the multiple-plane reference mirror in accordance with an example embodiment of the present invention may be configured such that unit patterns 501 having a uniform area ratio are repeatedly and evenly distributed in the entire mirror.

That is, the unit patterns having a uniform area ratio of the planes are evenly distributed in the entire mirror such that the area ratio of the planes of the multiple-plane reference mirror 330 is not varied according to the diameter of the coherence beam of the OCT apparatus.

For example, the unit patterns may be configured such that the planes included in the unit patterns have a rectangular shape 510 or a circle-divided shape 520 to correspond to the area ratio of the planes determined through the formula 2, and so on.

The mirror may be used as the multiple-plane reference mirror without relation (or sensitivity) to the diameter of the coherence beam. However, in order to prevent diffraction due to the unit patterns, the unit patterns may have a much larger size (Px, Py) than a central wavelength λ of the light source 100. This can be represented by the following formula 3.

Px,Py>>λ [Formula 3]

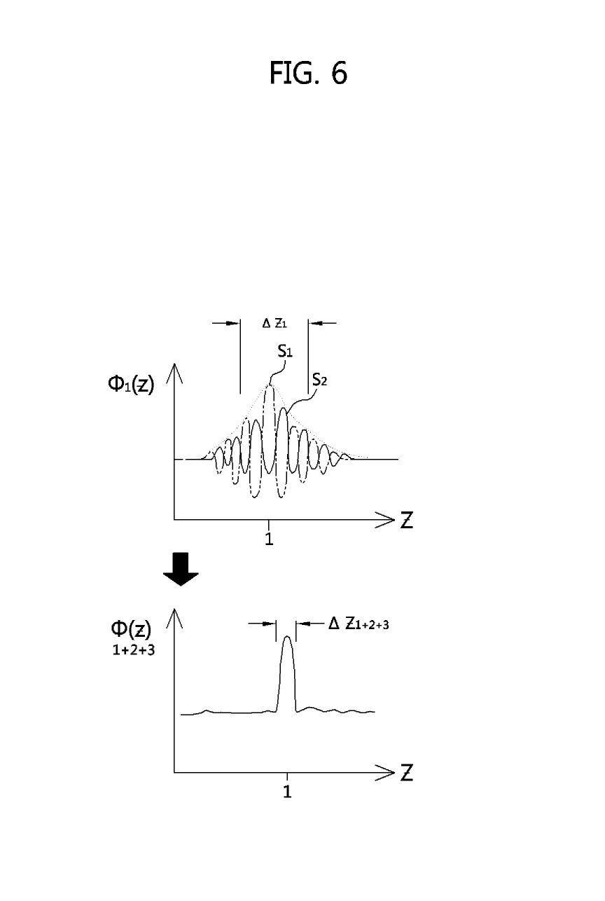

FIG. 6 is a light intensity output signal graph of an object to be measured in a depth direction of the OCT apparatus in accordance with the example embodiment of the present invention.

An amplitude of the signal reflected by the first plane S₁ of the multiple-plane reference mirror 330 has a phase shift corresponding to a half wavelength (or an odd multiple of the half wavelength) with respect to an amplitude of the signal reflected by the second plane S₂ so that the signals interfere with each other to provide a coherence light intensity.

The multiple-plane reference mirror 330 in accordance with the example embodiment of the present invention has planes constituted by three phase planes, and the sum of the beams reflected by all of the planes is represented as a resultant coherence light intensity (Φ₁₊₂₊₃(Z)). Areas of the planes may be adjusted to offset all of peripheral modulations except for a central peak. In particular, when the number of planes is three, the planes may be configured such that fine signals around the central signal, rather than the central signal, can be symmetrically offset.

Therefore, since a line width in the depth direction including fine modulations is reduced to a line width in the depth direction, from which the fine modulations are removed, resolution in the depth direction can be remarkably increased.

As can be seen from the foregoing, when the OCT apparatus capable of improving the contrast in the depth direction in accordance with an example embodiment of the present invention is used, as the multiple planes are formed at the surface of the reference mirror such that beams reflected by the planes have a phase shift corresponding to a half wavelength or an odd multiple of the half wavelength, image contrast in the depth direction of the object to be measured can be remarkably improved. Since the technique is not accomplished by increasing the bandwidth of the light source, the other optical parts of the OCT apparatus do not require large broadband performance or dispersion compensation of the path in each coherence arm.

Therefore, this technique can be applied in industries that require various thick film techniques, such as a pharmaceutical industry, a semiconductor industry, a plastic element industry, a transparent element industry, and a medical instrument industry, through the tomography image having the remarkably enhanced contrast in the depth direction.

While the example embodiments of the present invention and their advantages have been described in detail, it should be understood that various changes, substitutions and alterations may be made herein without departing from the scope of the invention.

What is claimed is:

1. An optical coherence tomography (OCT) apparatus configured to branch and irradiate beams emitted from a light source to a reference mirror and a sample mirror, and obtain a coherence tomography image of an object to be measured through a coherence signal generated by a path difference between a beam reflected by the reference mirror and a beam reflected by the object to be measured via the sample mirror,
wherein the reference mirror is a multiple-plane reference mirror having at least two planes, and is configured such that the beams reflected from the planes have a phase shift corresponding to a half wavelength or an odd multiple of the half wavelength.

2. The OCT apparatus of claim 1, wherein the reference mirror comprises:
a first plane; and
at least one second plane having a height difference corresponding to ¼ length of a central wavelength of the light source or an odd multiple of ¼ length with respect to the first plane.

3. The OCT apparatus of claim 1, wherein the reference mirror has three planes, and an area ratio of the first plane and the second and third planes is determined in proportion to a ratio of light intensity of a central signal of the coherence signal and light intensity of a first fine modulation signal.

4. The OCT apparatus of claim 1, wherein the reference mirror is constituted by unit patterns having at least two planes and distributed on a surface of the reference mirror.

5. The OCT apparatus of claim 4, wherein the unit patterns have a size larger than a central wavelength of the light source.

6. An optical coherence tomography (OCT) apparatus comprising a light source and an optical detection part, the apparatus comprising:
an optical branching filter configured to amplitude-divide beams emitted from the light source;
a reference mirror having multiple planes configured to reflect the beams divided from the optical branching filter and introduce the reflected beams of the divided beams into the optical detection part;
a sample mirror configured to irradiate the beams divided from the optical branching filter to a surface of an object to be measured, and introduce the beams reflected from the object to be measured into the optical detection part; and
a control unit configured to move the reference mirror onto a path axis of the divided beam to adjust a reflected beam path of the divided beam, and rotate the sample mirror to move the beam irradiated onto the surface of the object to be measured,
wherein the reference mirror is a multiple-plane reference mirror having at least two planes, and is configured such that the beams reflected from the planes have a phase shift corresponding to a half wavelength or an odd multiple of the half wavelength.

7. The OCT apparatus of claim 6, wherein the reference mirror comprises:
a first plane; and
at least one second plane having a height difference corresponding to ¼ length of a central wavelength of the light source or an odd multiple of ¼ length with respect to the first plane.

8. The OCT apparatus of claim 6, wherein the reference mirror has three planes, and an area ratio of the first plane and the second and third planes is determined in proportion to a ratio of light intensity of a central signal of the coherence signal and light intensity of a first fine modulation signal.

9. The OCT apparatus of claim 6, wherein the reference mirror is constituted by unit patterns having at least two planes and distributed on a surface of the reference mirror.

10. The OCT apparatus of claim 9, wherein the unit patterns have a size larger than a central wavelength of the light source.

11. The OCT apparatus of claim 6, wherein the optical detection part comprises:
a focusing lens configured to focus the beams from the reference mirror and the sample mirror;
an iris configured to adjust a quantity of the beams passed through the focusing lens; and
an optical detector configured to detect the beam passed through the iris.

12. The OCT apparatus of claim 6, wherein the optical branching filter is an optical beam splitter or an optical fiber coupler.

13. A reference mirror applied to an optical coherence tomography (OCT) apparatus configured to branch and irradiate beams emitted from a light source to the reference mirror and a sample mirror, and obtain a coherence tomography image of an object to be measured through a coherence signal generated by a path difference between a beam reflected by the reference mirror and a beam reflected by the object to be measured via the sample mirror, the reference mirror comprising:
a first plane; and
at least one second plane having a height difference corresponding to ¼ length of a central wavelength of the light source or an odd multiple of ¼ length with respect to the first plane.

14. The reference mirror of claim 13, wherein the reference mirror has three planes, and an area ratio of the first plane and the second and third planes is determined in proportion to a ratio of light intensity of a central signal of the coherence signal and light intensity of a first fine modulation signal.

15. The reference mirror of claim 13, wherein the reference mirror is constituted by unit patterns having at least two planes and distributed on a surface of the reference mirror.

16. The reference mirror of claim 15, wherein the unit patterns have a size larger than a central wavelength of the light source.
